(19) United States
(12) Patent Application Publication
(10) Pub. No.: US 2011/0051558 A1
(43) Pub. Date: Mar. 3, 2011

(54) System for Determining the Work Time of a Work Tool

(75) Inventors: Mark Janssen, Groesbeek (NL); Joost Luyendijk, Rosmalen (NL)

(73) Assignee: CATERPILLAR INC., Peoria, IL (US)

(21) Appl. No.: 12/547,730

(22) Filed: Aug. 26, 2009

(51) Int. Cl. G04F 10/00

(52) U.S. Cl. 368/1

(57) ABSTRACT

A system for determining the work time of a work tool is disclosed. The system has a work tool. The system also has a work tool movement sensor adapted to produce a signal indicative of a movement of the work tool. The system further has a controller adapted to produce a signal indicative of a work time of the work tool as a function of the movement of the work tool.

### TECHNICAL FIELD

The present disclosure is directed to a system for determining the work time, more particularly to a system for determining the work time of a work tool.

### BACKGROUND

Work tools, such as shears, grabs, or buckets are oftentimes coupled with host machines, such as excavators, to perform work operations like cutting, grabbing or excavating. The work tools may be coupled to a boom or stick mechanism of a host machine via a fixed connection or a quick release connection. The latter allows for a relatively easy exchange of the work tool.

Presently, it is hard to determine how much time a work tool has actually been working. There is commonly no registry of the actual work time of the work tool, wherein the work tool has been coupled to the machine and has been performing work actions such as cutting, grabbing or excavating. Because it is not known for how much time a particular work tool has actually been working it is difficult to determine whether or when a work tool is due for repair, maintenance or service. Further, it may be difficult to determine what the remaining lifetime of the work tool may be. It is therefore desirable to be able to measure work time of the work tool.

Hour meters for measuring work time are known per se. An hour meter that is activated by vibration is manufactured by the Sendec® Corporation. This hour meter may be known in the field as the Sendec® 806-6xx series. This hour meter is configured to be coupled directly to a vibrating part of a machine combustion engine, and starts accumulating work time if a certain level of vibration is measured. This hour meter is however not suitable for accurately measuring work tool work time. When the vibration activated hour meter would be connected to the engine of a work tool carrying mobile machine such as an excavator, the work time of specific work tools would not be determined accurately since the work tool work time is in practice independent of the work time of the machine. Hence, the operating time of the machine would be determined, instead of the operating time of the work tool. For example, the machine may be driving while the work tool that is coupled to the machine is not in operation. A further problem may be that work tools are oftentimes coupled, uncoupled and exchanged between each other.

The system and method of the present disclosure solves one or more of the problems set forth above.

### SUMMARY OF THE INVENTION

In one aspect, the present disclosure is directed to a system for determining the work time of a work tool. The system includes a work tool. The system also includes a work tool movement sensor adapted to produce a signal indicative of a movement of the work tool. The system further includes a controller adapted to produce a signal indicative of a work time of the work tool as a function of the movement of the work tool.

In another aspect, the present disclosure is directed to a method of determining the work time of a work tool. The method includes sensing a movement of the work tool. The method further includes determining the work time of the work tool as a function of the movement of the work tool.

### BRIEF DESCRIPTION OF THE DRAWINGS

FIG. 1 is a side-view illustration of an exemplary host machine having a work tool coupled thereto;

FIG. 2 is an exploded view illustration in perspective of an exemplary work tool having a work tool hour meter coupled thereto;

FIG. 3 illustrates a block diagram of system circuitry corresponding to an exemplary disclosed embodiment;

FIG. 4 illustrates a flow chart of an embodiment of a method of determining the work time of the work tool.

### DETAILED DESCRIPTION

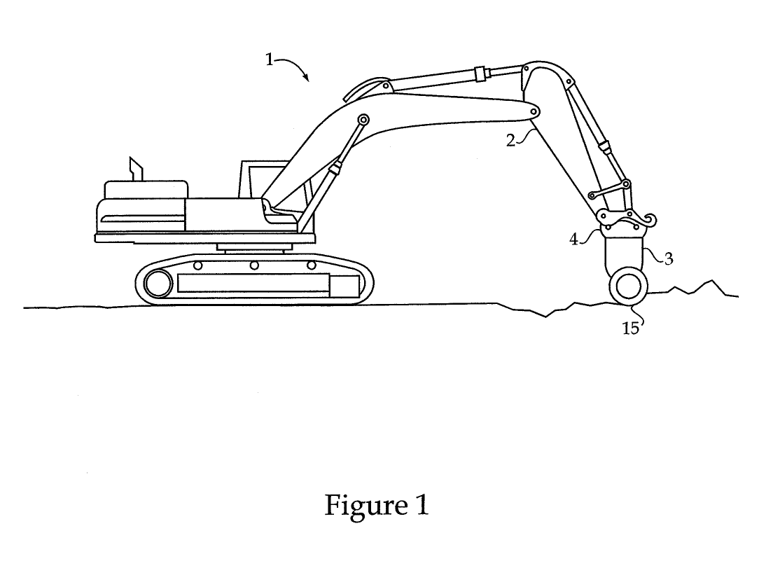

FIG. 1 illustrates an exemplary machine 1, which may be a host machine 1. The machine 1 may be a mobile machine such as for example an excavator, a back hoe, a digger, a loader, a knuckle boom loader, a harvester or a forest machine. The machine 1 as shown in the exemplary embodiment of FIG. 1 is a hydraulic excavator, provided with a boom mechanism, in particular a hydraulic boom mechanism 2. A work tool 3 may be coupled to the machine 1. In the exemplary embodiment shown, the work tool 3 comprises a rotary cutter. In other embodiments, usable work tools 3 may for example include cutters, augers, buckets, blades, brooms, cutters, cold planers, compactors, delimbers, forks, grapples, hammers, hoppers, mulchers, multi-processors, pulverizers, rakes, rippers, saws, scarifiers, shears, plows, grinders, thumbs, tillers, trenchers, truss booms, or the like. For example, the work tool 3 may comprise a frame that in itself carries multiple exchangeable and/or interexchangeable tools. In an embodiment, the work tool 3 may comprise a demolition work tool 3, or at least a work tool 3 for heavy duty applications.

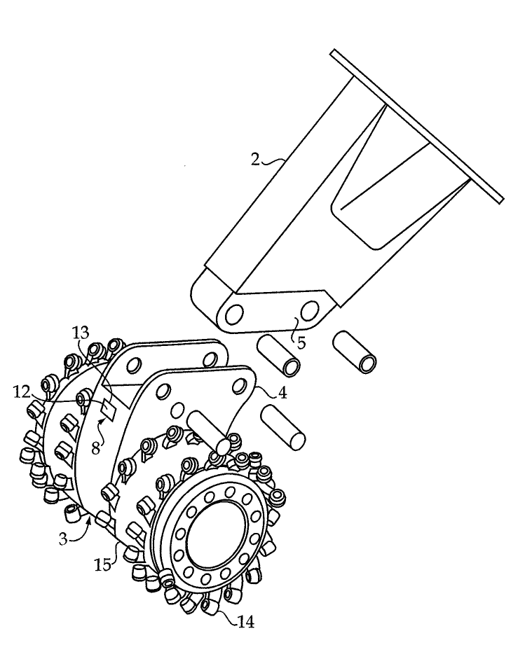

FIG. 2 illustrates an exemplary disclosed embodiment of a work tool 3. In the shown example the work tool 3 comprises a rotary cutter. The work tool 3 may for example comprise a connection part 4, arranged to connect the work tool 3 to the machine 1. For example, the work tool 3 may be connected to the boom 2 and/or stick of the machine 1 and/or to an adapter or coupler 5 that may be provided between the machine 1 and the work tool 3, by the connection part 4. In the field, such an adapter or coupler may also be known as a quick coupler. The connection part 4 may comprise a bracket for connection which the coupler 5. Next to couplers, also sub couplers, or even sub-sub couplers may be coupled between the machine 1 and the work tool 3. Also, a standard linkage of holes and pins may be applied.

In a system for determining work time of a work tool 3, a work tool movement sensor 6 may be provided, that is adapted to produce a signal indicative of a movement of the work tool 3. A controller 7 may be provided, the controller 7 being adapted to produce a signal indicative of a work time of the work tool 3 as a function of the movement of the work tool 3. The movement sensor 6 may be provided near, for example onto, the connection part 4 of the work tool 3. The controller 7 may be arranged at any location, such as for example in the cab of the machine 1, or together with the movement sensor 6 in one unit on the work tool 3, or at a distant location. On the basis of the signal that is produced by the movement sensor 6, the controller 7 may determine the work time of the work tool 3. The controller 7 may be adapted to register and accumulate the sensed work time, so that a total accumulated work time of the respective work tool 3 may be obtained.

In an embodiment, a work tool hour meter 8 may be provided, for determining the work time of the work tool 3. The work tool hour meter 8 may comprise the controller 7 and the movement sensor 6, the controller 7 and movement sensor 6 for example being packed together, or for example being physically separated. A total accumulated work time of the work tool 3 may be read from the work tool hour meter 8.

In an embodiment, multiple movement sensors 6 or work tool hour meters 8 may be provided on multiple parts of the work tool 3, which work tool 3 may comprise a sub-coupler with multiple exchangeable tools, wherein each tool or some of the tools is/are provided with a movement sensor 6 or controller 7. Likewise, multiple hour meters 8 may be provided.

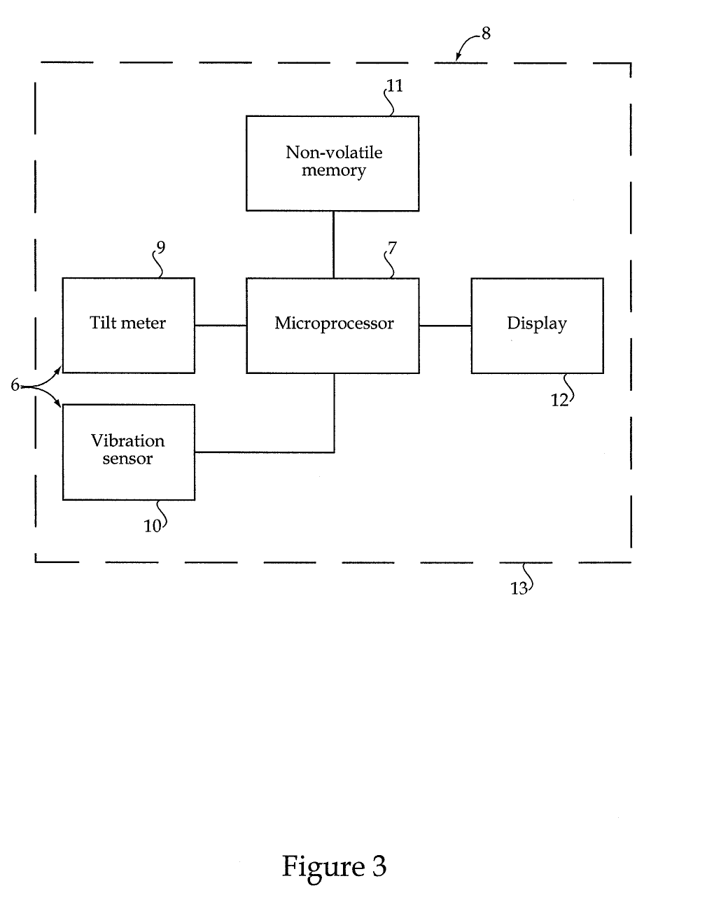

FIG. 3 illustrates a block diagram of exemplary disclosed circuitry for the system for determining the work time of a work tool 3. The controller 7 may comprise a microprocessor that may be pre-programmed to accumulate work time only when the work tool 3 is moving. The controller 7 may be configured to store data of the machine 1 and/or work tool 3 it relates to. In another exemplary embodiment, the controller 7 may comprise a clock circuit, for example comprise a digital or analogue clock circuit that is activated by movement of the work tool 3.

The controller 7 may start accumulation of time automatically when the work tool 3 starts operating. To this end, the movement sensor 6 may be provided. The movement sensor 6 may be provided in and/or on the work tool 3 and generate a signal indicative of a movement of the work tool 3. The movement sensor 6 may be relatively small. The controller 7 may be pre-programmed to interpret the signal of the movement sensor 6 according to the work tool 3 and/or work machine 1 it relates to. In an embodiment, the controller 7 is arranged at a distance from the movement sensor 6. For example, the movement sensor 6 may be arranged on the work tool 3, while the controller 7 may be arranged in the machine 1 or at a different location on the work tool 3. A connection circuit that connects the movement sensor 6 and the controller 7 may for example comprise a wired and/or wireless connection circuit.

In another embodiment, the controller 7 may for example be configured to be activated by operation of an operating panel by an operator in the machine 1, for which for example a connection may be established between the machine operating panel and the controller 7. In yet another embodiment, the controller 7 may be arranged to be activated by mechanical activation of the work tool 3.

A movement may be understood as at least an angular change and/or a vibration that is indicative of a work operation of the work tool 3. The movement sensor 6 may comprise an arrangement that is configured to generate a signal indicative of angular movement of the work tool 3. Several angular movement detecting arrangements are known in the art, such as for example accelerometers, inclinometers and tilt meters. In an embodiment the movement sensor 6 may comprise a tilt meter 9. The tilt meter 9 may for example be a relatively small tilt meter 9 or tilt sensor, arranged to detect an angular change, for example in two or three orthogonal directions. The tilt meter 9 may for example comprise an electrolytic tilt sensor.

In another embodiment, the movement sensor 6 may comprise an arrangement configured to generate a signal indicative of vibration of the work tool 3. Several vibration detecting arrangements are known in the art. The movement sensor 6 may comprise a vibration sensor 10, for example comprising a piezoelectric wafer. The vibration sensor 10 may be arranged to detect a vibration that is indicative of a work operation of the work tool 3. The vibration sensor 10 may be configured to distinguish vibrations due to work operations of the work tool 3 from other vibrations, such as vibrations due to the running engine of the machine 1. For example, the vibrations due to working actions of the work tool 3 may be relatively irregular and/or at a relatively low frequency, as compared to the vibrations of a running combustion engine of a machine 1. Hence, the vibration sensor 10 may produce a signal indicative of work tool vibrations only when the work tool 3 is working. The vibration sensor 10 may not be activated when only the machine engine is running while the work tool 3 is not performing work.

In yet another embodiment, the movement sensor 6 may comprise both an arrangement that is configured to generate a signal indicative of angular movement of the work tool 3, and an arrangement configured to generate a signal indicative of vibration of the work tool 3, for example a tilt meter 9 and a vibration sensor 10, respectively. The controller 7 may be configured to produce a signal as a function of on or both of angular movement and vibration. The controller 7 may be configured to produce a signal according to a preprogrammed level or frequency of movement.

The controller 7 may for example be configured to compare the incoming signal of the movement sensor 6 to a reference value, and accumulate work time only when this signal equals or exceeds the reference value. For example, the controller 7 may be configured to accumulate work time only when a minimum angular change of the work tool 3 is measured, i.e. wherein the reference value may comprise a minimum angular change of the work tool 3, for example approximately three or five degrees. In another embodiment the reference value may comprise a minimum level and/or frequency of vibration. In yet another embodiment the reference value may comprise a minimum angular change and a minimum level and/or frequency of vibration.

A storage arrangement such as a non-volatile memory 11 may be provided for storing the determined and/or accumulated work time. The non-volatile memory 11 may prevent loss of data due to lack of power. Also other types of storage arrangements may be provided. For example, a wired or wireless connection may be established between the controller 7 and a distant storage arrangement, which storage arrangement may for example be provided in the machine 1.

A work time indicating interface, such as a display 12, may be provided, for indicating the accumulated work time of the work tool 3. The work tool hour meter 8 may be provided with the display 12, wherein the work tool hour meter 8 and the display may be directly attached and/or integrated with the work tool 3. The work time indicating interface may comprise a wired or wireless interface with a computer that is physically separated from the controller 7 and/or movement sensor 6, for example a computer that is provided in the machine 1, or a computer that is stationed at a secure location of a provider of the work tool 3. A wireless interface could for example be established through radiofrequency waves or other wireless connections known in the art. Consequently, accumulated work time may for example be read from a display 12 separate of the work tool hour meter 8.

The work tool hour meter 8 may comprise a housing 13 that may for example house the controller 7, the non-volatile memory 11 and the display 12. The housing 13 may also house the movement sensor 6, comprising the tilt meter 9 and/or the vibration sensor 10. A power supply may be provided within the housing 13 for supplying power to the elements of work tool hour meter 8. Preferably, the power supply comprises an independently operating power supply such as a battery, or a self supplying power source such as a solar cell. The power supply may supply low voltage power, for example between one and five Volts, for example 1.5 Volts, which may be enough to supply power to the controller 7 and/or the other elements for more than ten years. The power supply may be arranged within a housing 13 of the work tool hour meter 8, for example so that it cannot be exchanged without damaging the hour meter 8.

The system may be configured such that after switching on the controller 7, resetting or switching off the controller 7 is impeded. Hence, tampering of the work time determining system may be prevented, by preventing that someone could restart accumulation of work time from zero by shortening a warranty or rent time that is coupled to the measured work time. For example, the system could be provided with an activation element that after activation cannot be reactivated. For example, activation may be achieved by cutting or breaking an element, for example a conductive wire that after it has been cut through activates the power supply and/or the movement sensor 6 and/or the controller 7. Reconnecting that element will not have an effect to the system. In another embodiment an activation element of the work tool hour meter 8 may be provided at a back surface of the work tool hour meter 8, with which surface the work tool hour meter 8 is attached to the work tool 3, so that after attachment the work tool hour meter 8 cannot be reactivated. In again other embodiments, the circuitry is protected by a solid housing that is arranged to remain closed to protect the housing. Also the controller 7 may be configured to prevent resetting. In yet another embodiment, it may still be possible to reset the work tool hour meter 8, for example exclusively by the provider of the work tool 3.

The housing 13 may for example be arranged so as to impede that the housing 13 or a part thereof can be removed and/or tampered with. For example, the work tool hour meter 8 is arranged so that it can only be released from the work tool 3 by damaging the work tool hour meter 8, and/or its housing 13. In an embodiment, a relatively strong adhesive and/or compound may be applied, for example covering the entire work tool hour meter 8, screws may be hidden and/or one-way screws may be applied. The work tool hour meter 8 may for example be covered by a transparent compound and/or plastics material. Preferably, the housing 13 is arranged such that if one would try to open or remove a part of the housing 13, a visual mark is left as proof of tampering.

The system for determining work time may be provided with an indicator that is configured to generate a user perceptible signal to the environment when a predetermined amount of accumulated work time is exceeded. The predetermined amount of accumulated work time may for example relate to a service that is needed, or a warranty that is about to expire. For example, the display 12 may be arranged to provide for a blinking and/or flickering action, and/or a sound generating element such as a speaker may be provided.

The movement sensor 6 and/or controller 7 may be arranged such that it is prevented that it is damaged by a working action of the work tool 3. In an embodiment, the work tool hour meter 8 may be located onto the work tool 3 such that its display 12 may be visible for readily reading the accumulated work time. Since a working part 14 of the work tool 3 may be provided near a distal end 15 of the work tool 3, it may be advantageous when the movement sensor 6 and/or controller 7 are arranged at a location that is distanced and/or protected from the working part 14 of the work tool 1 and/or from parts that may fly around during a work action of the work tool 3. To this end, the movement sensor 6 and/or controller 7 may be provided near or onto the connection part 4 of the work tool 1. Additionally and/or alternatively, a solid housing 13 such as a steel cover and/or an additional strong coating may be provided that may prevent damaging of the inside of the housing 13 and/or the display 12. In another embodiment, the movement sensor 6 and/or work tool hour meter 8 are integrated with the work tool 3. For example, the work tool 3 comprises a cavity wherein the movement sensor 6 and/or other such as the controller 7 circuitry may be fitted. In yet another embodiment, a surface of the housing 13 may have an opening for reading the display 12, wherein the display 12 has a front surface that is arranged at a deepened level as compared to the surface of the housing 13. This may prevent the display 12 being damaged, for example by parts that may fly around during a work action of the work tool 3.

### INDUSTRIAL APPLICABILITY

In general, work tools 3 are used for handling heavy materials. For example, work tools may demolish, drill, dig, plow, cut, grab and/or carry heavy materials which may include sand, stone, metal, and more. Work tools 3 may be coupled to and powered by machines 1, in particular mobile host machines. The machine 1 may be provided with transmissions, hydraulic equipment, booms 2 and/or sticks for driving the work tool 3. Work tool operations may be controlled by the operator via an operating panel of the machine. When the work tool 3 is handling materials, it is actually working. In contrast, when the work tool 3 is coupled to the machine 1, the machine 1 may be operating, while the work tool 3 is not operating.

According to an exemplary disclosed method, it may be determined that the work tool 3 is in actually working by sensing a movement of the work tool 3, and a signal is generated in response thereto. In response to the signal, the work time of the work tool 3 may be determined and accumulated. The work time of the work tool 3 may be determined and accumulated until the work tool 3 stops working. Thereafter the accumulated work time number of the work tool 3 may be stored and optionally displayed. When the work tool 3 resumes to work, accumulation of time may be resumed starting from the stored amount of time. In this manner, the total work time of the work tool 3 concerned may be determined, preferably throughout the lifetime of the work tool 3. The total work time of the work tool 3 can for example be used for reliability prediction, rent, maintenance, lifetime estimation and/or warranty purposes.

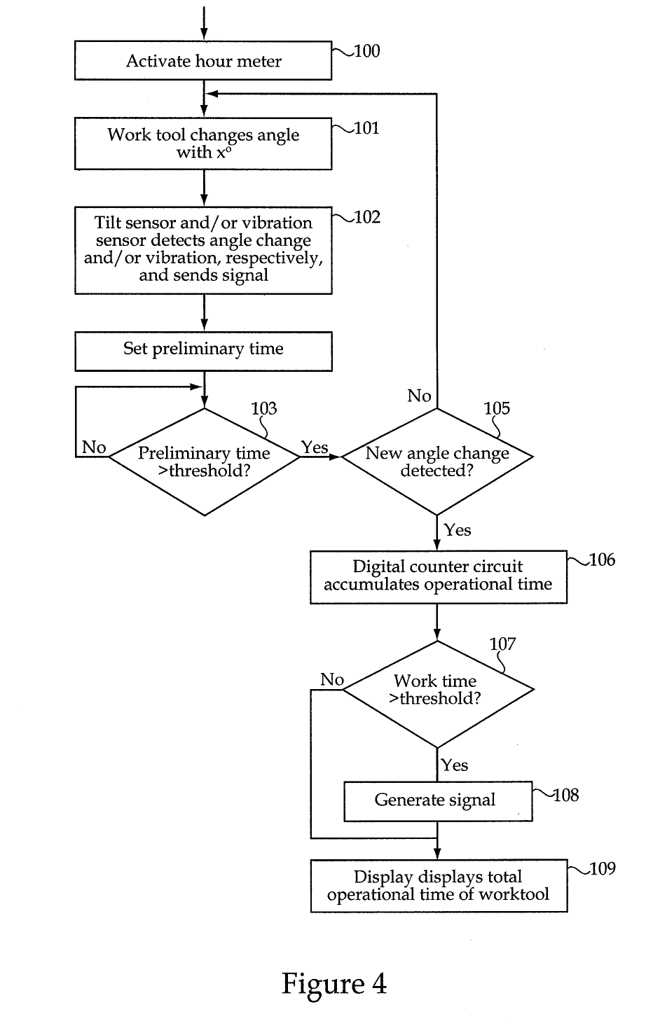

Referring to the exemplary disclosed flow chart in FIG. 4, at a first step 100 the work tool hour meter 8 may be activated. In an embodiment, the work tool hour meter 8 may be activated by an activation element that can only be activated once. In another exemplary embodiment, only the provider of the work tool 3 can activate the work tool hour meter 8. The work tool 3 may be coupled to a machine 1. The work tool 3 may start working, for example it may start demolishing. At step 101 the work tool 1 may make particular movements, for example it may vibrate and/or change angle. At step 102, the movement sensor 6 may generate a signal in response to said movement.

In an exemplary embodiment, a signal will only be generated if the respective movement exceeds a certain reference value, so that small movements will not trigger the controller 7 to produce a corresponding signal.

In response to the signal the controller 7 may determine and accumulate work time, or first preliminary start counting time. A preliminary counting of time may start after a first angular change and/or vibration has been measured. Only if a second or next angular change and/or vibration are measured before a preprogrammed threshold amount of time has exceeded, work time may be continued to be accumulated by the controller 7. At step 103 it may be determined if the preliminary time has reached a said predetermined threshold amount of time. In this way, the determining of the work time is started only when the work tool continues with moving longer than a predetermined time period.

In an embodiment, accumulation of work time may only start or continue if the movements are detected more frequent than a certain threshold frequency. For example, the frequency may be at least one movement every several seconds or every several tens of seconds. Thus, if before the threshold amount of preliminary time has expired a new movement is detected, accumulation of work time may be started or continued. At step 105, it is determined if new angular changes and/or vibrations are detected before the threshold time is reached. If since the last angular change and/or vibration was detected, no new angular changes and/or vibrations are detected, the frequency of movements may be lower than the threshold frequency. Then, the accumulation of work time may cease or not start, and a preliminary counting of time will not start again before a new vibration and/or angular change is detected. By setting a threshold frequency, coincidental movements of the work tool 3, for example due to transportation of the work tool 3, may not be counted as work time. Also, when the work tool 3 that is coupled to the machine 1 pauses in between work operations, accumulation of work time may also pause. If before said predetermined threshold is reached or has been exceeded, a new angle change and/or vibration of the work tool 3 is detected, it may be assumed that the work tool 3 is working. Then, at step 106, the controller 7 may start or continue accumulation of work time. After every detected movement of the work tool 3 the controller 7 may start preliminary counting of time from zero, and determine if the frequency of movements that are detected is higher than a preset threshold frequency.

At step 107 it is determined if a certain predetermined threshold amount of work time is reached or exceeded. If this threshold is reached or exceeded, at step 108, a signal may be generated by the indicator. This signal may for example comprise a flickering, blinking and/or light of the display 12 and/or a sound, or any user perceptible signal. This signal can be perceived by the user, and may for example indicate that the predetermined amount of work time is reached. The predetermined amount may for example relate to an amount of work time of the work tool 3 close to or after which a service is required, or to an amount of work time close to or after which a warranty period expires. At step 109 the display 12 may indicate the total accumulated work time of the work tool 3.

With the system for determining the work time of the work tool 3, work tools 3 may for example be leased according to operational lease contracts based on work hours of the work tool 3. Work tool 3 warranties may for example be based on work time. It may be determined when to apply preventive maintenance of the work tool 3 according to the work hours of the work tool 3. A residual value of the work tool 3 may be determined or at least estimated based on the work hours. Lifetimes and time-to-failure dates of the work tool 3 or parts thereof may be determined and used for future product improvements.

It shall be readily apparent to the skilled person that various modifications and variations can be made in the disclosed system and/or work tool 3 without departing from the scope or spirit of the disclosure. Other embodiments of the disclosure will be apparent to those skilled in the art from consideration of the specification and practice of the disclosure disclosed herein. It is intended that the specification and examples be considered as exemplary only. Although the preferred embodiments of this disclosure have been described herein, improvements and modifications may be incorporated without departing from the scope of the following claims.

What is claimed is:

1. System for determining the work time of a work tool, comprising:
a work tool;
a work tool movement sensor adapted to produce a signal indicative of a movement of the work tool; and
a controller adapted to produce a signal indicative of a work time of the work tool as a function of the movement of the work tool.

2. System according to claim 1, wherein the movement sensor is adapted to produce a signal indicative of angular movement of the work tool.

3. System according to claim 1, wherein the movement sensor is adapted to produce a signal indicative of vibration of the work tool.

4. System according to claim 1, wherein the controller is configured to produce a signal indicative of work time only when the work tool moves at a frequency that is higher than a threshold frequency.

5. System according to claim 1, comprising a work time indicating interface, in connection with the controller, configured to indicate the work time of the work tool.

6. System according to claim 1, wherein the work time comprises an accumulated total work time of the work tool, and the controller is adapted to accumulate work time.

7. System according to claim 6, wherein the system is configured such that after it is switched on, resetting or switching off the controller is impeded.

8. System according to claim 1, comprising an indicator that is configured to generate a user perceptible signal to the environment when a predetermined amount of work time is exceeded.

9. System according to claim 1, wherein:
the work tool is provided with a connection part for connecting the work tool with a machine; and
the movement sensor is arranged near the connection part.

10. System according to claim 1, wherein the controller and the movement sensor are arranged in a housing, the housing being arranged such that removing a part of the housing from the work tool without leaving a visual mark is impeded.

11. Method of determining the work time of a work tool, comprising:
sensing a movement of a work tool; and
determining the work time of the work tool as a function of the movement of the work tool.

12. Method according to claim 11, wherein the movement comprises at least one of an angular change, and a change in vibration of the work tool.

13. Method according to claim 11, wherein a movement signal is generated in response to a vibration in combination with an angular change of the work tool.

14. Method according to claim 11, wherein only when the frequency of movement is higher than a predetermined threshold frequency the work time is determined.

15. Method according to claim 11, wherein determining the work time is started only when the work tool continuously moves longer than a predetermined time period.
